(19) United States
(12) Patent Application Publication
(10) Pub. No.: US 2026/0172968 A1
(43) Pub. Date: Jun. 18, 2026

(54) TRANSMISSION DIVERSITY SCHEMES FOR LOW-POWER WAKE UP SIGNALS

(71) Applicant: QUALCOMM Incorporated, San Diego, CA (US)

(72) Inventors: Weimin DUAN, San Diego, CA (US); Huilin XU, Temecula, CA (US); Kangqi LIU, San Diego, CA (US)

(21) Appl. No.: 18/981,216

(22) Filed: Dec. 13, 2024

(51) Int. Cl. H04W 52/02

(52) U.S. Cl. CPC H04W 52/0235

(57) ABSTRACT

Methods, systems, and devices for wireless communications are described. A UE may receive control signaling indicating wakeup signal resources and precoder cycling parameters including time domain precoding resource groups, bundling time domain resource block groups, or both. Additionally, or alternatively, the UE may receive control signaling indicating a cyclic delay diversity value. A UE may monitor for low-power wake up signals during on-durations of an on-off keying reception window, and a UE may receive the low-power wake up signals in accordance with the precoder cycling parameters, in accordance with a timing of the monitoring based on the cyclic delay diversity value, or both.

### FIELD OF TECHNOLOGY

The following relates to wireless communications, including transmission diversity schemes for low-power wake up signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating a set of multiple wakeup signal (WUS) resources and precoder cycling parameters including time domain precoding resource groups (TD-PRGs), bundling time domain resource block groups (TD-RBGs), or both, monitoring for low-power wake up signals (LP-WUS) during one or more on-durations of an on-off keying (OOK) reception window, and receiving the LP-WUSs in accordance with the precoder cycling parameters.

A UE for wireless communications is described. The UE may include one or more memories storing processor executable code, and one or more processors coupled with the one or more memories. The one or more processors may individually or collectively be operable to execute the code to cause the UE to receive control signaling indicating a set of multiple wakeup signal resources and precoder cycling parameters including TD-PRGs, bundling TD-RBGs, or both, monitor for LP-WUSs during one or more on-durations of an OOK reception window, and receive the LP-WUSs in accordance with the precoder cycling parameters.

Another UE for wireless communications is described. The UE may include means for receiving control signaling indicating a set of multiple wakeup signal resources and precoder cycling parameters including TD-PRGs, bundling TD-RBGs, or both, means for monitoring for LP-WUSs during one or more on-durations of an OOK reception window, and means for receiving the LP-WUSs in accordance with the precoder cycling parameters.

A non-transitory computer-readable medium storing code for wireless communications is described. The code may include instructions executable by one or more processors to receive control signaling indicating a set of multiple wakeup signal resources and precoder cycling parameters including TD-PRGs, bundling TD-RBGs, or both, monitor for LP-WUSs during one or more on-durations of an OOK reception window, and receive the LP-WUSs in accordance with the precoder cycling parameters.

Some examples of the method, UEs, and non-transitory computer-readable medium described herein may further include operations, features, means, or instructions for receiving, via the control signaling, an indication of a single bit precoder duration, where one precoder of the TD-PRGs corresponds to each of the durations.

Some examples of the method, UEs, and non-transitory computer-readable medium described herein may further include operations, features, means, or instructions for receiving, via the control signaling, an indication of a sub-bit precoder duration, where multiple precoders of the TD-PRGs correspond to each of the on-durations.

In some examples of the method, UEs, and non-transitory computer-readable medium described herein, a quantity of the bundling TD-RBGs corresponding to the OOK reception window may be based on a quantity of precoders in a cycle of precoders, such that each of the quantity of precoders occurs at least once during the quantity of the bundling TD-RBGs during the OOK reception window.

In some examples of the method, UEs, and non-transitory computer-readable medium described herein, each precoder of the cycle of precoders corresponds to a respective beam.

In some examples of the method, UEs, and non-transitory computer-readable medium described herein, a quantity of the bundling TD-RBGs may be based on a subcarrier spacing configured at the UE.

Some examples of the method, UEs, and non-transitory computer-readable medium described herein may further include operations, features, means, or instructions for receiving, via the control signaling, an indication of a time period during which a first precoder of a set of multiple precoders may be applied in accordance with the bundling TD-RBGs.

Some examples of the method, UEs, and non-transitory computer-readable medium described herein may further include operations, features, means, or instructions for receiving, via the control signaling, an indication of a precoder cycling pattern, where receiving the LP-WUSs may be based on applying the precoder cycling pattern.

Some examples of the method, UEs, and non-transitory computer-readable medium described herein may further include operations, features, means, or instructions for receiving an indication of a precoder of a set of multiple candidate precoders to be applied to each respective TD-RBG of the bundling TD-RBGs in accordance with the TD-PRGs.

Some examples of the method, UEs, and non-transitory computer-readable medium described herein may further include operations, features, means, or instructions for performing phase coherent processing during the on-durations of the OOK reception window on the LP-WUSs based on the indication of the precoder to be applied to each respective TD-RBG.

A method for wireless communications by a UE is described. The method may include receiving a control message including an indication of a cyclic delay diversity (CDD) delay value, monitoring for LP-WUSs during an on-duration of an OOK reception window, where a timing of the monitoring is based on the CDD delay value, and receiving the LP-WUSs in accordance with the timing.

A UE for wireless communications is described. The UE may include one or more memories storing processor executable code, and one or more processors coupled with the one or more memories. The one or more processors may individually or collectively be operable to execute the code to cause the UE to receive a control message including an indication of a CDD delay value, monitor for LP-WUSs during an on-duration of an OOK reception window, where a timing of the monitoring is based on the CDD delay value, and receive the LP-WUSs in accordance with the timing.

Another UE for wireless communications is described. The UE may include means for receiving a control message including an indication of a CDD delay value, means for monitoring for LP-WUSs during an on-duration of an OOK reception window, where a timing of the monitoring is based on the CDD delay value, and means for receiving the LP-WUSs in accordance with the timing.

A non-transitory computer-readable medium storing code for wireless communications is described. The code may include instructions executable by one or more processors to receive a control message including an indication of a CDD delay value, monitor for LP-WUSs during an on-duration of an OOK reception window, where a timing of the monitoring is based on the CDD delay value, and receive the LP-WUSs in accordance with the timing.

In some examples of the method, UEs, and non-transitory computer-readable medium described herein, the indication of the CDD delay value includes an explicit indication of the CDD delay value.

In some examples of the method, UEs, and non-transitory computer-readable medium described herein, receiving the indication of the CDD delay value may include operations, features, means, or instructions for receiving an indication that the CDD delay value may be applied to one or more reference signals (RS), where the one or more RSs may be quasi co-located (QCL) with the LP-WUSs and measuring a power delay profile (PDP) length of the one or more RSs, where receiving the CDD delay value may be determined based on the measuring.

In some examples of the method, UEs, and non-transitory computer-readable medium described herein, the one or more RSs include tracking RSs, synchronization signal block (SSB) signals, or both.

Some examples of the method, UEs, and non-transitory computer-readable medium described herein may further include operations, features, means, or instructions for adjusting the timing of the monitoring based on receiving the indication of the CDD delay value, where the timing of the monitoring corresponds to a timing of an on-off monitoring decision window.

Some examples of the method, UEs, and non-transitory computer-readable medium described herein may further include operations, features, means, or instructions for performing phase coherent processing during the on-duration of the OOK reception window on the LP-WUSs based on the CDD delay value.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports transmission diversity schemes for low-power wake up signals in accordance with one or more aspects of the present disclosure.

FIG. 2 shows an example of a wireless communications system that supports transmission diversity schemes for low-power wake up signals in accordance with one or more aspects of the present disclosure.

FIG. 3 shows an example of a signaling diagram that supports transmission diversity schemes for low-power wake up signals in accordance with one or more aspects of the present disclosure.

FIG. 4 shows an example of a process flow that supports transmission diversity schemes for low-power wake up signals in accordance with one or more aspects of the present disclosure.

FIG. 5 shows an example of a process flow that supports transmission diversity schemes for low-power wake up signals in accordance with one or more aspects of the present disclosure.

FIGS. 6 and 7 show block diagrams of devices that support transmission diversity schemes for low-power wake up signals in accordance with one or more aspects of the present disclosure.

FIG. 8 shows a block diagram of a communications manager that supports transmission diversity schemes for low-power wake up signals in accordance with one or more aspects of the present disclosure.

FIG. 9 shows a diagram of a system including a device that supports transmission diversity schemes for low-power wake up signals in accordance with one or more aspects of the present disclosure.

FIGS. 10 through 15 show flowcharts illustrating methods that support transmission diversity schemes for low-power wake up signals in accordance with one or more aspects of the present disclosure.

### DETAILED DESCRIPTION

In some wireless communications systems, a network entity may apply one or more transmission delay diversity schemes (e.g., a time domain resource block group (RBG)-level precoder cycling, a large delay cyclic delay diversity (LD-CDD), or a small delay CDD (SD-CDD), among other examples of transmission delay diversity schemes). In some cases, a resource element-level frequency domain precoder cycling and a SD-CDD may produce similar transmission gains. In some cases, when utilizing a CDD, a receiving device such as a user equipment (UE) may determine a delay spread (e.g., a threshold or maximum delay of the SD-CDD or the LD-CDD) based on tracking reference signals (TRSs). To obtain a more precise delay value of the SDCDD, the network entity may apply the SD-CDD to the TRS. However, in such situations where the SD-CDD is not applied to the TRS, the SD-CDD value may be limited to relatively small delay values. As such, transmission diversity may correspondingly be limited. Additionally, or alternatively, applying a relatively large SD-CDD value may shift a transition point of an on-off keying (OOK) signal, which may impact reception of the OOK signal by a UE (e.g., within an expected time window for the OOK signal reception). Additionally, or alternatively, transmissions via a given carrier may be performed via relatively few frequency resources (e.g., resulting in limited diversity), which may impact the effectiveness of frequency domain precoder cycling. Such situations may impact the detection and reception of low-power wake up signals (LP-WUS), which may be transmitted according to an OOK scheme.

Techniques described herein may support transmission delay diversity by enabling time domain precoder cycling. In some examples, the network entity may indicate a configuration (e.g., precoder cycling parameters) for one or more time domain precoding resource groups (TD-PRG), one or more time domain resource block groups (TD-RBG), or both. The indication of the time domain precoder cycling parameters may be included within a resource configuration for one or more LP-WUSs. In some examples, a granularity of the time domain precoder cycling may be based on a quantity of beams per polarization of the LP-WUSs, a cross polarization co-phasing of the LP-WUSs, a subcarrier spacing, or other parameters. In some examples, the granularity (e.g., a bit duration granularity) may be such that an on-duration of the OOK LP-WUS includes a single precoder (e.g., a single precoder is applied for each bit of the LP-WUS). In some examples, the granularity (e.g., a sub-bit duration granularity) may be such that the on-duration of the OOK LP-WUS may include multiple precoders (e.g., multiple precoders may be applied for each bit of the LP-WUS). In some examples, the network entity may explicitly indicate a precoder that is applied to each TD-RBG. In some examples, a precoder cycling pattern may include a sequence of precoders applied across the configured TD-RBGs (e.g., according to the TD-PRGs). The precoder cycling pattern may be applied to a single LP-WUS, or multiple LP-WUS. Additionally, or alternatively, indicating the precoder cycling parameters to a UE may enable the UE to receive LP-WUSs during an on-duration of an OOK reception window.

Additionally, or alternatively, techniques described herein may enable a transmitting device (e.g., the network entity) to indicate a SD-CDD value to the UE in a semi-transparent manner. In some implementations, the network entity may explicitly indicate an SD-CDD value to the UE (e.g., via control signaling). In some other implementations, the network entity may implicitly indicate a SD-CDD value. In such implementations, the network entity may indicate that one or more reference signals that are quasi co-located (QCL) with the LP-WUS may have the SD-CDD applied.

Accordingly, the UE may measure an effective channel power delay profile (PDP) length for the one or more reference signals and determine the SD-CDD based on measuring the PDP. Additionally, or alternatively, the UE may adjust an OOK reception window based at least in part on determining or receiving an indication of the SD-CDD value, and the UE may receive the LP-WUS during the on-duration of the OOK reception window.

Aspects of the disclosure are initially described in the context of wireless communications systems. Aspects of the disclosure are further described in the context of wireless communications systems, signaling diagrams, and process flows. Aspects of the disclosure are further illustrated by and described with reference to apparatus diagrams, system diagrams, and flowcharts that relate to transmission diversity schemes for low-power wake up signals.

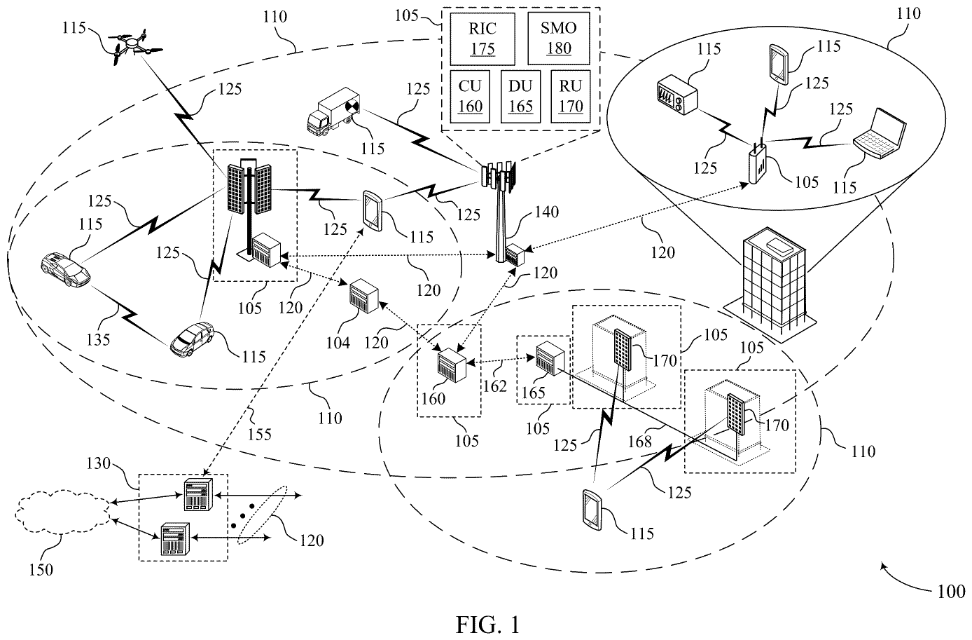

FIG. 1 shows an example of a wireless communications system 100 that supports transmission diversity schemes for low-power wake up signals in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support transmission diversity schemes for low-power wake up signals as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission-duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Wireless networks may adopt various techniques and technologies to conserve power. One such example power saving technique may include use of a low-power wakeup radio (LP-WUR) at a user equipment (UE) that may be used in combination with or instead of a main radio (MR) when the UE is in a lower power state, such as a sleep state. For example, the LP-WUR may be used to monitor for LP-WUS transmissions or low-power synchronization signal (LP-SS) transmissions. The LP-WUS transmissions may carry or otherwise convey an indication of whether the UE needs to transition to another state, such as a higher power state or an awake state, and power up the MR to perform wireless communications with a network. Such low-power (LP) signal transmissions may use OOK modulation for low-complexity envelope detection by the LP-WUR. A LP-WUR may be a low-complexity and low power radio that can detect an OOK LP-WUS and then turn on other components of the UE for subsequent communications. In some UEs, the LP-WUR may be an in-phase/quadrature (I/Q)-based radio that has a lower noise floor (NF) and higher processing gain then a simple OOK-based radio, which can substantially enhance reliability of receiving the WUS while still providing relatively low-cost and low-power WUR.

Techniques described herein may support transmission delay diversity by enabling time domain precoder cycling. In some examples, the network entity may indicate a configuration (e.g., precoder cycling parameters) for one or more TD-PRGs, one or more TD-RBGs, or both. The indication of the time domain precoder cycling parameters may be included within a resource configuration for one or more LP-WUSs. In some examples, the granularity (e.g., a bit duration granularity) may be such that an on-duration of the OOK LP-WUS includes a single precoder (e.g., a single precoder is applied for each bit of the LP-WUS). In some examples, the granularity (e.g., a sub-bit duration granularity) may be such that the on-duration of the OOK LP-WUS may include multiple precoders (e.g., multiple precoders may be applied for each bit of the LP-WUS). In some examples, the network entity may explicitly indicate a precoder that is applied to each TD-RBG, and a precoder cycling pattern may include a sequence of precoders applied across the configured TD-RBGs (e.g., according to the TD-PRG). The precoder cycling pattern may be applied to a single LP-WUS, or multiple LP-WUS. Additionally, or alternatively, indicating the precoder cycling parameters to a UE may enable the UE to receive LP-WUSs during an on-duration of an OOK reception window.

Additionally, or alternatively, techniques for indicating a SD-CDD value to the UE in a semi-transparent manner may be defined. In some implementations, the network entity may explicitly indicate a SD-CDD value to the UE (e.g., via RRC signaling, MAC control elements (MAC-CEs), or other signaling). In some other implementations, the network entity may implicitly indicate a SD-CDD value. In such implementations, the network entity may indicate that one or more reference signals (e.g., TRSs, synchronization signal blocks (SSBs), or other reference signals) that are quasi co-located with the LP-WUS may have the SD-CDD applied. Accordingly, the UE may measure an effective channel power delay profile (PDP) length for the one or more reference signals and determine the SD-CDD based on measuring the PDP. Additionally, or alternatively, the UE may adjust an OOK reception window based at least in part on determining or receiving an indication of the SD-CDD value, and the UE may receive the LP-WUS during the on-duration of the OOK reception window.

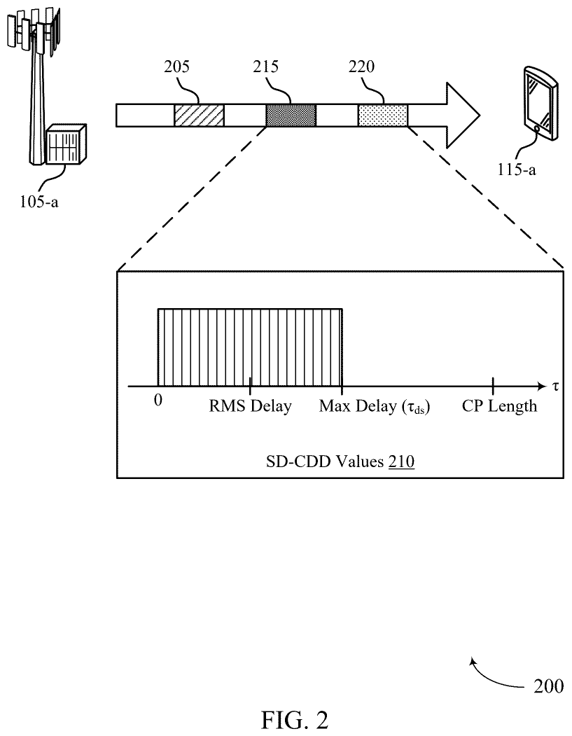

FIG. 2 shows an example of a wireless communications system 200 that supports transmission diversity schemes for low-power wake up signals in accordance with one or more aspects of the present disclosure. In some implementations, the wireless communications system 200 may implement or be implemented by aspects of the wireless communications system 100. For example, the wireless communications system 200 may include (e.g., be implemented by) a network entity 105-a and a UE 115-a, which may be examples of the network entity 105 and the UE 115 respectively.

Wireless devices may support wireless communications via OFDM waveforms. In some cases, for OFDM waveforms, a network entity (e.g., the network entity 105-a) may apply CDD to one or more transmissions. For example, an initial transmission S₀(k) (e.g., which may be referred to as a transmission signal or symbol, among other examples) may have an initial cyclic delay δ. Additionally, or alternatively, the network entity may transmit one or more additional transmissions Sᵢ(k) (e.g., transmissions including the data of the initial transmission) with one or more different cyclic delays δ (e.g., phase delays relative to the initial transmission). In some cases, the additional transmissions Sᵢ(k) may be defined by Equation 1, which is shown below.

$${S}_{i} ( k ) = \frac{1}{\sqrt{{N}^{T}}} \cdot \tilde{s} ( k - {δ}_{i} ) \qquad ( 1 )$$

In such examples, a quantity i of additional transmissions may be included for i=0, . . . , N_{T}−1, where N_{T} is a quantity of samples of transmission antennas or groups of transmission antennas. Additionally, or alternatively, an example of a CDD delay scheme (e.g., a large delay CDD (LD-CDD scheme) may be given in Table 1, which is shown below.

TABLE 1

| | 2Tx | 4Tx |
|---|---|---|
| R = 1 | No Cycling | ${C}_{0}^{( 1 )} , {C}_{1}^{( 1 )} , {C}_{2}^{( 1 )} , {C}_{3}^{( 1 )}$ |
| R = 2 | $\frac{1}{\sqrt{2}} [ \begin{matrix}1 & 1 \\ {e}^{- j 2 π i / 2} & - {e}^{- j 2 π i / 2}\end{matrix} ]$ | $\frac{1}{\sqrt{2}} {C}_{i}^{( 2 )} [ \begin{matrix}1 & 1 \\ {e}^{- j 2 π i / 2} & - {e}^{- j 2 π i / 2}\end{matrix} ]$ |
| R = 3 | N/A | $\frac{1}{\sqrt{3}} {C}_{i mod 4}^{( 3 )} [ \begin{matrix}1 & 1 & 1 \\ {e}^{- j 2 π i / 3} & {e}^{- j 2 π / 3} {e}^{- j 2 π i / 3} & {e}^{- j 4 π / 3} {e}^{- j 2 π i / 3} \\ {e}^{- j 4 π i / 3} & {e}^{- j 4 π / 3} {e}^{- j 4 π i / 3} & {e}^{- j 8 π / 3} {e}^{- j 4 π i / 3}\end{matrix} ]$ |
| R = 4 | N/A | $\frac{1}{2} {C}_{i mod 4}^{( 4 )} [ \begin{matrix}1 & 1 & 1 & 1 \\ {e}^{- j 2 π i / 4} & - {je}^{- j 2 π i / 4} & - {e}^{- j 2 π i / 4} & {je}^{- j 2 π i / 4} \\ {e}^{- j 4 π i / 4} & - {e}^{- j 4 π i / 4} & {e}^{- j 4 π i / 4} & - {e}^{- j 4 π i / 4} \\ {e}^{- j 6 π i / 4} & {je}^{- j 6 π i / 4} & - {e}^{- j 6 π i / 4} & - {je}^{- j 6 π i / 4}\end{matrix} ]$ |

In such cases,

$${C}_{0}^{( r )} , {C}_{1}^{( r )} , {C}_{2}^{( r )} , {C}_{3}^{( r )}$$

may denote rank-r precoding matrices corresponding to indices 12, 13, 14, 15, respectively, where R denotes a transmission rank (e.g., Rank 1, Rank 2, etc., among other examples). In some cases, LD-CDD schemes may be inconsistent with multi-port demodulation reference signal (DMRS) schemes (e.g., such that a UE may be unable to receive and process transmissions with LD-CDD applied). In such cases, a small delay CDD (SD-CDD) transmission scheme may be applied instead in a transparent manner (e.g., applied by the network entity such that the SD-CDD scheme is transparent to the UE).

In some cases, the network entity may output a quantity of N_{FFT} data symbols S( [symbol] ), such that [symbol] =0, . . . , N_{FFT}−1. The data symbols may then by transformed via an inverse fast Fourier transform (IFFT), and the network entity may output the data symbols according to a delay value and a cyclic prefix such that Sᵢ(k) may be given by Equation 2, shown below.

$${S}_{i} ( k ) = \frac{1}{\sqrt{{N}^{T}}} \cdot \tilde{s} ( k - {δ}_{i}^{cyc} mod {N}_{FFT} ) \qquad ( 2 )$$

In some cases, the index i may be between i=0, . . . , N_{T}−1, and the index k may be between k=−N_{G}, . . . , N_{FFT}−1.

In some examples, a receiving device may receive the data symbols, remove the cyclic prefix, and perform a fast Fourier transform (FFT) on the received data symbols. In such cases, the received data symbols may be defined by Equation 3, shown below.

$$R ( l ) = [ \frac{1}{\sqrt{{N}^{T}}} {\sum }_{i = 0}^{{N}_{T} - 1} {e}^{- j \frac{2 π}{{N}_{FFT}} {δ}_{i}^{cyc}} {H}_{i} ( l ) ] S ( l ) + N ( l ) \qquad ( 3 )$$

In such cases, the received data symbols may be modified by an effective channel (e.g., H(l)), where a delay (e.g., a maximum delay for the data symbols) after applying the CDD may be given by Equation 4, shown below.

$$[ ( {δ}_{max}^{cyc} + {N}_{max} ) mod {N}_{FFT} ] \times {τ}_{s} , \qquad ( 4 )$$

In such cases, the maximum delay applied to the data symbols may be defined by

$${δ}_{max}^{cyc} = {max}_{i} {δ}_{i}^{cyc} ,$$

where Nₘₐₓ is the maximum channel delay (e.g., in terms of samples), and τₛ is the sampling rate (e.g., the sampling rate of the receiving device).

Additionally, or alternatively, the effective channel delay H(l) may be given by Equation 5, shown below.

$$H ( l ) = [ {H}_{0} ( l ) , , {H}_{{N}_{T} - 1} ( l ) ] \cdot \frac{1}{\sqrt{{N}^{T}}} [ \begin{matrix}{e}^{- j \frac{2 π}{{N}_{FFT}} {δ}_{0}^{cyc} l} \\ ⋮ \\ {e}^{- j \frac{2 π}{{N}_{FFT}} {δ}_{{N}_{T}}^{cyc} l}\end{matrix} ] S ( l ) + N ( l ) \qquad ( 5 )$$

In such cases, the precoding vector for an l-th resource element (RE) may be given by Equation 6, shown below.

$$\frac{1}{\sqrt{{N}^{T}}} [ \begin{matrix}{e}^{- j \frac{2 π}{{N}_{FFT}} {δ}_{0}^{cyc} l} \\ ⋮ \\ {e}^{- j \frac{2 π}{{N}_{FFT}} {δ}_{{N}_{T}}^{cyc} l}\end{matrix} ] \qquad ( 6 )$$

Applying the CDD (e.g., CDD delay spread) to the data symbols according to Equations 2 through 5 may be equivalent (e.g., may produce similar performance characteristics, or similar delay diversity results, among other examples) to applying RE-level precoder cycling.

In some cases, a transmitting device (e.g., the network entity, among other examples) may apply SD-CDD (e.g., to one or more data symbols). In such cases, the transmitting device may apply SD-CDD such that a cyclic delay value

$${δ}_{max}^{cyc}$$

may satisfy

$${δ}_{max}^{cyc} < CP length - {N}_{max} .$$

In such cases, the receiving device may transparently measure a delay spread (e.g., a maximum delay combining the channel delay and the cyclic delay) by using a tracking reference signal (TRS) (e.g., regardless of whether SD-CDD is applied to the TRS). In some examples, the receiving device may perform a channel estimation based on the delay spread (e.g., the max delay), and the receiving device may subsequently perform a demodulation of the data symbols (e.g., based on transparently measuring the delay spread). In some cases, (e.g., to relatively increase the accuracy of delay information), the TRS may also apply the SD-CDD. In some other cases, (e.g., when the TRS is not applying SD-CDD), the

$${δ}_{max}^{cyc}$$

value may be restricted to a relatively small value (e.g., a relatively small delay value), which may limit transmission diversity gain.

In such cases, a transmitting device may apply SD-CDD. In some examples, SD-CDD may be beneficial when a channel has limited frequency diversity (e.g., a tapped delay line (TDL-A channel with a relatively small delay spread). However, for OOK signals, the CDD value may be selected based on a performance tradeoff. For example, having relatively small CDD value may limit transmission diversity, but having a relatively large CDD value may affect the OOK detection performance by shifting the on/off transition point in time across different transmission antennas (e.g., the on/off transition point for OOK signals may be different across different transmission antennas having different delays).

In some cases, for LP-WUS, reception diversity may be limited by limited receiver antenna chains. In such cases, increased transmission diversity may relatively increase the reliability of LP-WUS (e.g., compared to situations with reduced transmission diversity). For example, transmission diversity schemes such as SD-CDD or precoder cycling may provide performance improvements for LP-WUS detection.

In some cases, open-loop MIMO may support RBG-level precoder cycling (e.g., frequency domain precoder cycling). In some cases, the RBG-level precoder cycling may be based on a UE frequency resource configuration (e.g., UE frequency resource parameters). For example, a UE frequency resource configuration may include a minimum quantity of resource blocks (RBs), a maximum quantity of RBs, a physical resource block (PRB) building size (e.g., bundling of 2 RBs, bundling of 4 RBs, or wideband PRB bundling, among other examples), and a quantity of precoding resource groups (PRGs). For an example, a UE may have various frequency resource configurations as depicted in Table 2, shown below.

TABLE 2

| Bundling Size | Minimum | Maximum |
|---|---|---|
| 2 | 12 | 138 |
| 4 | 8 | 69 |
| Wideband | 1 | 1 |

In some cases, each bit of an OOK signal may be modulated by a phase signal pre-DFT. Accordingly, the transmitting device (e.g., the network entity) may apply a precoder in time domain on the pre-DFT signal. For example, to transmit an on signal on two antennas, the transmitter may transmit [x₁, x₂, x₃, . . . , x_{M}] on one antenna, and transmit

$$[ {x}_{1} , … , {x}_{M / 2} - {x}_{\frac{M}{2} - 1} , … , - {x}_{M} ]$$

on a second antenna, where x₁, x₂, x₃, . . . , x_{M} are the pre-DFT signal for OOK-4. In such cases, the first half of the on symbol may be precoded by a [1,1] precoder, and the second half of the on signal is precoded by a [1,−1] precoder. In such cases, the precoder cycling may be applied within the on-duration of an OOK symbol (e.g., intra-OOK precoder cycling). For OFDM-based waveforms, the precoder cycling is conducted in the frequency domain (e.g., the PRG bundling is a frequency domain concept).

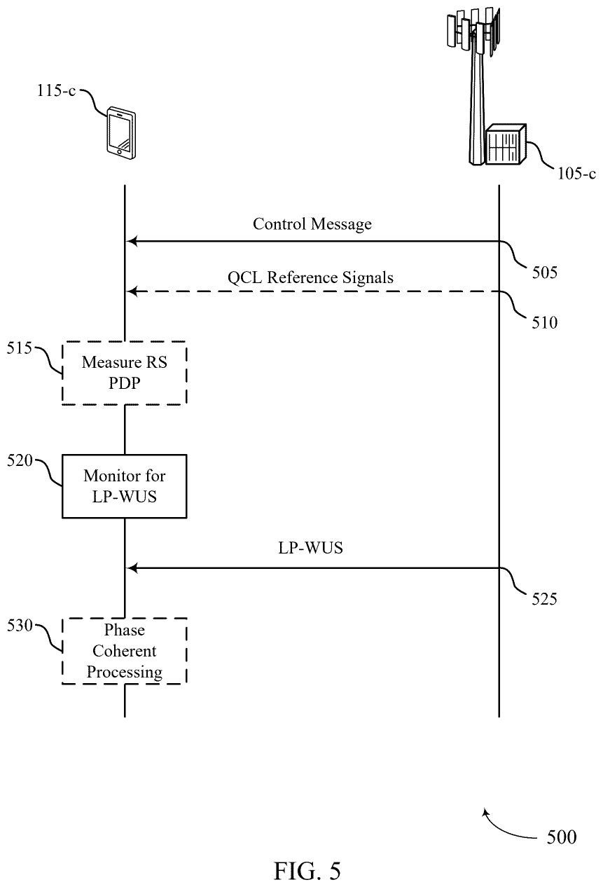

Techniques described herein may enable a transmitting device (e.g., the network entity 105-a) to relatively increase a transmission diversity for LP-WUS by applying time domain precoder cycling, SD-CDD, or both. In some implementations (e.g., further described herein with reference to FIG. 5), the network entity 105-a may indicate (e.g., to the UE 115-a) a SD-CDD value applied to one or more LP-WUSs. For example, in some implementations, the network entity 105-a may output control signaling 205, which may indicate a SD-CDD value applied to one or more transmissions. For example, the control signaling 205 may indicate (e.g., explicitly indicate) the SD-CDD value applied to one or more LP-WUSs. In such examples, the network entity 105-a may apply one or more SD-CDD values 210 to the LP-WUSs. In some examples, the one or more SD-CDD values 210 may include (e.g., be defined by) a maximum configured cyclic delay Tas, a cyclic prefix length (CP length), and a root-mean-squared (RMS) delay value, among other parameters.

In some implementations, the network entity 105-a may output one or more reference signals 215 (e.g., one or more TRSs, among other examples of reference signals). In some examples, the network entity 105-a may apply the one or more SD-CDD values 210 to the one or more reference signals 215. In some examples, the network entity 105-a may indicate (e.g., implicitly indicate) the one or more SD-CDD values 210 via the control signaling 205. In such examples, the UE 115-a may receive the one or more reference signals 215 and may determine (e.g., transparently measure) the one or more SD-CDD values 210 based on the one or more reference signals 215 (e.g., based on the one or more SD-CDD values 210 being applied to the one or more reference signals 215).

In some implementations, the network entity 105-a may output a LP-WUS 220 (e.g., an OOK LP-WUS). Additionally, or alternatively, the network entity 105-a may apply the one or more SD-CDD values 210 to the LP-WUS 220. In some examples, the network entity 105-a may apply a same one or more SD-CDD values 210 to the one or more reference signals 215 and the LP-WUS 220. In such examples, the UE 115-a may receive the LP-WUS 220 (e.g., the OOK LP-WUS) during an on-duration of an OOK reception window. In such examples, the UE 115-a may adjust a timing of the OOK reception window based on the indication of the one or more SD-CDD values 210 (e.g., based on the explicit indication within the control signaling 205, or based on determining the one or more SD-CDD values 210 from the one or more reference signals 215). Additionally, or alternatively, the UE 115-a may perform coherent processing on the LP-WUS 220 during the on-duration of the OOK reception window based at least in part on the one or more SD-CDD values 210.

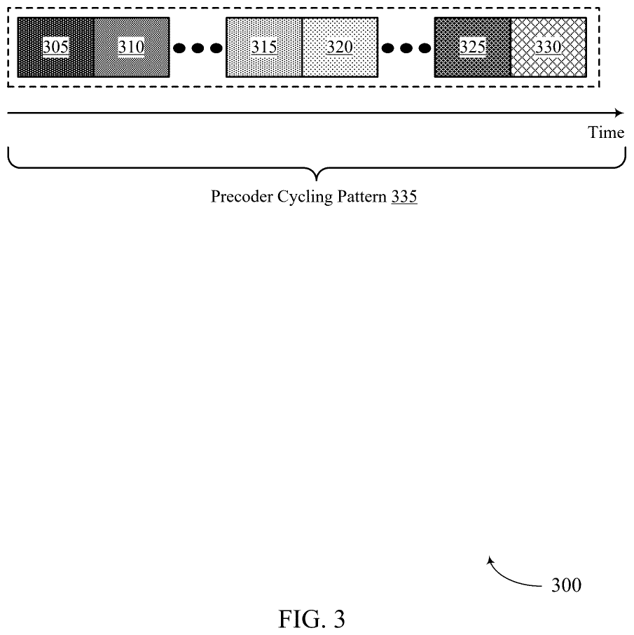

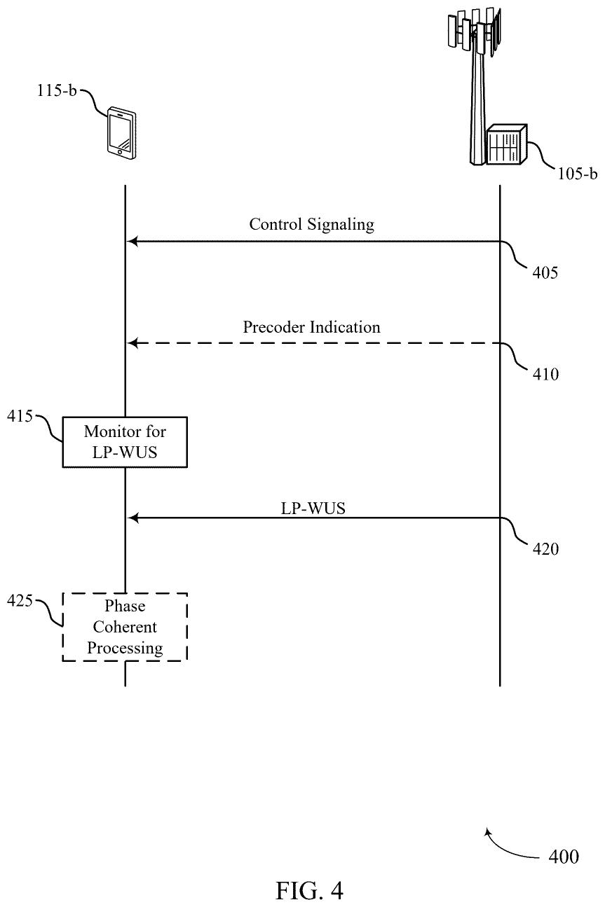

Additionally, or alternatively, in some implementations (e.g., further described herein with reference to FIGS. 3 and 4), the network entity 105-a may apply time domain precoder cycling to one or more LP-WUSs (e.g., including the LP-WUS 220). In such examples, applying the time domain precoder cycling to the LP-WUSs may relatively increase the transmission diversity of the LP-WUSs (e.g., compared to scenarios where the time domain precoder cycling is not applied).

FIG. 3 shows an example of a signaling diagram 300 that supports transmission diversity schemes for low-power wake up signals in accordance with one or more aspects of the present disclosure. In some implementations, the signaling diagram 300 may implement or be implemented by aspects of the wireless communications system 100 and the wireless communications system 200.

In some implementations, a transmitting device (e.g., a network entity) may perform intra-OOK precoder cycling. In some examples, for intra-OOK precoder cycling, the transmitting device may utilize multiple beams (e.g., communication beams) to communicate an OOK signal such as a LP-WUS. In such examples, the transmitting device may utilize the multiple beams for multiple different durations of the OOK signal. In some examples, further described herein with reference to FIG. 4, to effectively combine multiple OOK signals, the transmitting device may indicate to a receiving device (e.g., a UE) how the precoding is cycled in the time domain within the OOK signals (e.g., how the intra-OOK precoder cycling is applied to signals such as the LP-WUS).

In some implementations, control signaling (e.g., a resource configuration for a LP-WUS) may include an indication of one or more TD-PRGs, an indication of one or more TD-RBGs, or both. For example, the one or more TD-RBGs may include a TD-RBG 305, a TD-RBG 310, a TD-RBG 315, a TD-RBG 320, a TD-RBG 325, and a TD-RBG 330. In some examples, the transmitting device may cycle (e.g., apply in order) one or more precoders in time across resources indicated by one or more TD-RBGs according to a precoder cycling pattern 335 (e.g., and according to the TD-PRGs). For example, the precoder cycling pattern 335 may, based at least in part on the TD-PRGs, indicate one or more precoders to be applied for any grouping of the TD-RBG 305, the TD-RBG 310, the TD-RBG 315, the TD-RBG 320, the TD-RBG 325, and the TD-RBG 330, such that one or more precoders of a quantity of precoders (e.g., each precoder) corresponding to the multiple TD-RBGs of the precoder cycling pattern 335 may occur at least once during an OOK reception window (e.g., during an on-duration of the OOK reception window).

For an example, a resource configuration for an LP-WUS may include an indication of one or more TD-PRG (e.g., or a TD-PRG size) and an indication of one or more TD-RBGs. The TD-PRG may indicate a quantity of RBs for which the transmitting device may apply a single (e.g., a same) precoder for (e.g., a size or duration of the TD-PRG). In some examples, the resource configuration may include a quantity of TD-RBGs (e.g., based on the size of the TD-PRG, such that a large TD-PRG size may correspond to a smaller quantity of TD-RBGs, and a smaller TD-PRG size may correspond to a larger quantity of TD-RBGs). Accordingly, the UE may determine a pattern of precoders applied for each of the TD-RBGs (e.g., including the TD-RBG 305, the TD-RBG 310, the TD-RBG 315, the TD-RBG 320, the TD-RBG 325, the TD-RBG 330, among other TD-RBGs) based on the TD-RBGs indicated by or corresponding to the TD-PRG (e.g., indicating the precoder cycling pattern 335).

In some implementations, a granularity of the precoder cycling pattern 335 may correspond to a bit duration of the OOK signal (e.g., the OOK LP-WUS). In such implementations, the transmitting device may apply a single precoder for each on-duration of the OOK LP-WUS signal (e.g., across one or more TD-RBGs). For example, during an on-duration of an OOK LP-WUS, a single precoder may be applied for each configured TD-RBG (e.g., implementing the precoder cycling pattern 335 for the bit duration of the OOK LP-WUS).

In some other implementations, a granularity of the precoder cycling pattern 335 may correspond to a sub-bit duration of the OOK signals. In such implementations, the transmitting device may apply multiple precoders for each on-duration of the OOK LP-WUS signal (e.g., the transmitting device may apply one or more precoders for each configured TD-RBG). In such examples, a full cycle of the precoder cycling pattern 335 may include a relatively greater quantity of TD-RBGs (e.g., compared to the bit duration granularity). For example, a transmitting device may apply multiple precoders during an on-duration of an OOK LP-WUS (e.g., an application of multiple precoders at a sub-bit granularity). In such examples, each precoder may be applied for a relatively small quantity of RBs (e.g., compared to a bit duration granularity). Accordingly, each on-duration of the OOK LP-WUS may include a greater quantity of TD-RBGs (e.g., compared to a bit duration granularity) to achieve a full cycle of the precoder cycling pattern 335.

The quantity of TD-RBGs for a sub-bit duration granularity may be based on a quantity of beams per polarization, a cross-polarization (XPOL) co-phasing, a subcarrier spacing, or any combination thereof. For example, a TD-RBG configuration (e.g., and a corresponding precoder cycling pattern) for a scenario including four beams per polarization (e.g., 120° coverage with 30° half power beam width (HPBW), 60° coverage with 15° HPBW, or 30° coverage with 7.5° HPBW, among other examples) having an XPOL co-phasing of four may include 16 TD-RBGs. A relatively large bundling size may utilize a relatively large quantity of bits for the precoder cycling compared to smaller bundling size, which may decrease UE reception processing gain. In such examples, selecting a TD-RBG precoding bundling size (e.g., a TD-PRG) may include a tradeoff between diversity gain and UE reception processing gain (e.g., based on a tradeoff between a quantity of bits utilized and a quantity of different precoders used). In some examples, the network entity may select and configure the TD-RBGs and TD-PRG size to address such a tradeoff based on one or more conditions or parameters (e.g., biasing more towards improved diversity gain, or processing gain).

In some examples, the TD-PRG (e.g., indicated by the LP-WUS resource configuration) may indicate that the precoder cycling pattern 335 is applied for a period (e.g., the on-duration) within the LP-WUS. In some other examples, the precoder cycling pattern 335 may be a fixed precoder cycling pattern (e.g., defined in one or more standards documents, configured via control signaling, or preconfigured), which may enable enhanced LP-WUS combining across multiple instances of the LP-WUSs. In such examples, the precoder cycling pattern 335 may be the same (e.g., may be applied) across multiple different LP-WUS instances. For example, the TD-PRG indicated by a resource configuration for one or more LP-WUSs may define a precoder cycling pattern 335, which may apply for multiple different LP-WUS and may enable the UE to receive multiple LP-WUS during multiple on-durations for OOK reception windows.

FIG. 4 shows an example of a process flow 400 that supports transmission diversity schemes for low-power wake up signals in accordance with one or more aspects of the present disclosure. In some implementations, the process flow 400 may implement or be implemented by aspects of the wireless communications system 100 and the wireless communications system 200. For example, the process flow 400 may include (e.g., be implemented by) a network entity 105-b and a UE 115-b, which may be examples of the network entity 105 and the UE 115 respectively.

In some implementations, a transmitting device (e.g., a network entity) may perform intra-OOK precoder cycling. In some examples, for intra-OOK precoder cycling, the transmitting device may utilize multiple precoders and multiple beams (e.g., communication beams) to communicate an OOK signal such as a LP-WUS. In such examples, the transmitting device may utilize the multiple beams for multiple different durations of the OOK signal. In some examples, to effectively combine multiple OOK signals, the transmitting device may indicate to a receiving device (e.g., a UE such as the UE 115-b) how the precoders are cycled in the time domain within or across the OOK signals (e.g., how the intra-OOK precoder cycling is applied to signals such as the LP-WUS).

At 405, the network entity 105-b may output control signaling, which may indicate one or more TD-PRGs, one or more TD-RBGs, or any combination thereof (e.g., time domain precoder cycling parameters). In some examples, the control message may be included within a resource configuration for the one or more LP-WUSs (e.g., a resource configuration signaled between the network entity 105-b and the UE 115-b and indicating resources for LP-WUSs). In some examples, the control signaling (e.g., including an indication of the TD-PRGs and the TD-RBGs) may indicate (e.g., define) a time domain precoder cycling pattern, a granularity for the precoder cycling pattern (e.g., a bit duration or a sub-bit duration for one or more precoders), or the like.

At 410, the network entity 105-b may indicate to the UE 115-b a precoder applied for a grouping of RBs indicated by the TD-RBGs (e.g., semi-transparent intra-OOK precoder cycling). In some implementations, the network entity 105-b may indicate the TD-PRGs (e.g., the quantity of resources via which the same precoder may be applied, which may correspond to or be the same as a size of the TD-RBGs), the TD-RBGs (e.g., a quantity of TD-RBGs) and may additionally indicate an individual precoder that is applied for each TD-RBG of the TD-RBG bundles (e.g., candidate precoders). For example, the network entity 105-b may indicate that a first TD-RBG may be precoded by a ∠(1,1) precoder, a second TD-RBG may be precoded by a ∠(1,−j) precoder, a third TD-RBG may be precoded by a ∠(−1,−j) precoder, and so forth (e.g., according to a TD-RBG index). In some implementations, the indication of the precoder for each TD-RBG may be included within the control signaling of 405, different signaling, or any combination thereof.

At 415, the UE 115-b may monitor for a LP-WUS based on the precoder cycling parameters. In some examples, the UE 115-b may monitor for the LP-WUS during an on-duration of an OOK reception window. Additionally, or alternatively, the precoder cycling pattern may be applied during the on-duration of an OOK reception window. In some examples, indicating the precoder cycling parameters to the UE 115-b may enable the UE 115-b to receive the one or more LP-WUSs.

At 420, the network entity 105-b may output the LP-WUS. In some examples, outputting the LP-WUS may include applying the precoder cycling parameters (e.g., applying the precoder cycling pattern) to the LP-WUS (e.g., based on the TD-PRGs and the TD-RBGs). Accordingly, in some examples, the UE 115-b may receive the LP-WUS based on monitoring for the LP-WUS in during on-duration of the OOK reception window. Additionally, or alternatively, the UE 115-b may receive the LP-WUS during the on-duration of the OOK reception window based on the one or more precoders applied for the TD-RBGs (e.g., based on the indication of 410, the TD-PRGs, or both). In some examples, the network entity 105-b and the UE 115-b may communicate multiple OFDM symbols during the on-duration of the OOK reception window. In such examples, the network entity 105-b may apply the precoder cycling parameters to each OFDM symbol of the multiple OFDM symbols (e.g., for overlaid LP-WUS).

At 425, the UE 115-b may apply phase coherent processing to the LP-WUS (e.g., for a single LP-WUS, for overlaid LP-WUS, or for OFDM based receiver-based communications, among other examples). In such examples, the UE 115-b may perform coherent processing during the on-duration of the OOK reception window. Additionally, or alternatively, based on receiving the indication of a precoder applied to each TD-RBG of 410, the UE 115-b may jointly utilize resources for detection (e.g., reception resources for the LP-WUS) to maximize the processing gain of the UE 115-b, while simultaneously maintaining the transmission diversity gain.

FIG. 5 shows an example of a process flow 500 that supports transmission diversity schemes for low-power wake up signals in accordance with one or more aspects of the present disclosure. In some implementations, the process flow 500 may implement or be implemented by aspects of the wireless communications system 100 and the wireless communications system 200. For example, the process flow 500 may include (e.g., be implemented by) a network entity 105-c and a UE 115-c, which may be examples of the network entity 105 and the UE 115 respectively.

In some implementations, the network entity 105-c and the UE 115-c may implement semi-transparent SD-CDD. For example, the UE 115-c may adjust (e.g., shift) an on/off decision window (e.g., an on-duration of an OOK reception window) based on the SD-CDD. In some implementations further described herein with reference to FIG. 2, the network entity 105-c may apply a SD-CDD delay value to a LP-WUS.

At 505, the network entity 105-c may output a control message indicating an SD-CDD value (e.g., an SD-CDD value applied to one or more LP-WUSs). In some examples, the control message may be included within a resource configuration for the one or more LP-WUSs (e.g., a resource configuration signaled between the network entity 105-c and the UE 115-c and indicating resources for LP-WUSs). In some examples, the network entity 105-c may explicitly indicate the SD-CDD value applied to the LP-WUSs to the UE 115-c via the control message. In such examples, the control message may be an RRC message (e.g., RRC based SD-CDD value indication), a MAC-CE message (e.g., MAC-CE based SD-CDD value indication), or the like. In some examples, indicating the SD-CDD value via MAC-CE messages may enable or support dynamic SD-CDD indication.

In some other implementations, the network entity 105-c may provide (e.g., via the control message of 505) implicit signaling of the SD-CDD value applied on the LP-WUSs. In such implementations, the network entity 105-a may apply the same SD-CDD value on the LP-WUSs to one or more QCL (e.g., QCL-A or QCL-C) reference signals (e.g., one or more QCL TRSs, or one or more QCL synchronization signal blocks (SSBs), among other examples). In some examples, the network entity 105-c may indicate (e.g., via the control message) whether the SD-CDD value is applied to the one or more QCL reference signals.

At 510, the network entity 105-c may output, and the UE 115-c may receive, the one or more QCL reference signals. In such examples, at 515, the UE 115-c may measure an effective channel PDP length for the one or more QCL reference signals (e.g., based on the network entity 105-a indicating that the SD-CDD value is applied). In such examples, the measured effective channel PDP length may indicate (e.g., correspond to) the SD-CDD value applied to the LP-WUSs.

At 520, the UE 115-c may monitor for a LP-WUS based on the SD-CDD value (e.g., based on the explicit indication of the SD-CDD value applied to the LP-WUS, or based on determining the SD-CDD value from the QCL reference signals). In some examples, the UE 115-c may adjust a timing of a monitoring based on adjusting a timing of an on-duration of an OOK reception window (e.g., an OOK monitoring decision window). In some examples, the UE 115-c may adjust the on-duration of the OOK reception window to correspond to an on/off transition point of the OOK LP-WUS.

At 525, the network entity 105-c may output the LP-WUS. In some examples, outputting the LP-WUS may include applying the SD-CDD value to the LP-WUS. Accordingly, in some examples, the UE 115-c may receive the LP-WUS based on monitoring for the LP-WUS in during the adjusted on-duration of the OOK reception window. In some examples, the network entity 105-c and the UE 115-c may communicate multiple OFDM symbols during the on-duration of the OOK reception window. In such examples, the network entity 105-c may apply the SD-CDD value to each OFDM symbol of the multiple OFDM symbols (e.g., joint SD-CDD operation for overlaid LP-WUS).

At 530, the UE 115-c may apply phase coherent processing to the LP-WUS (e.g., for a single LP-WUS, or for the overlaid LP-WUS, among other examples). In such examples, the semi-transparent SD-CDD may relatively improve LP-WUS detection reliability (e.g., compared to scenarios where the SD-CDD may not be applied to the LP-WUS and indicated to the UE 115-c).

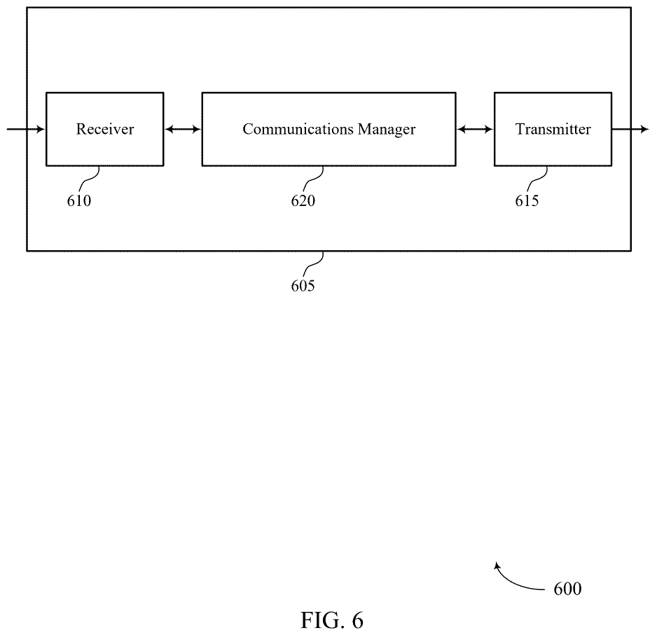

FIG. 6 shows a block diagram 600 of a device 605 that supports transmission diversity schemes for LP-WUSs in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to transmission diversity schemes for LP-WUSs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to transmission diversity schemes for LP-WUSs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of transmission diversity schemes for LP-WUSs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling indicating a set of multiple wakeup signal resources and precoder cycling parameters including TD-PRGs, bundling TD-RBGs, or both. The communications manager 620 is capable of, configured to, or operable to support a means for monitoring for LP-WUSs during one or more on-durations of an OOK reception window. The communications manager 620 is capable of, configured to, or operable to support a means for receiving the LP-WUSs in accordance with the precoder cycling parameters.

Additionally, or alternatively, the communications manager 620 may support wireless communications in accordance with examples as disclosed herein. For example, the communications manager 620 is capable of, configured to, or operable to support a means for receiving a control message including an indication of a CDD delay value. The communications manager 620 is capable of, configured to, or operable to support a means for monitoring for LP-WUSs during an on-duration of an OOK reception window, where a timing of the monitoring is based on the CDD delay value. The communications manager 620 is capable of, configured to, or operable to support a means for receiving the LP-WUSs in accordance with the timing.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced power consumption and more efficient utilization of communication resources, among other advantages.

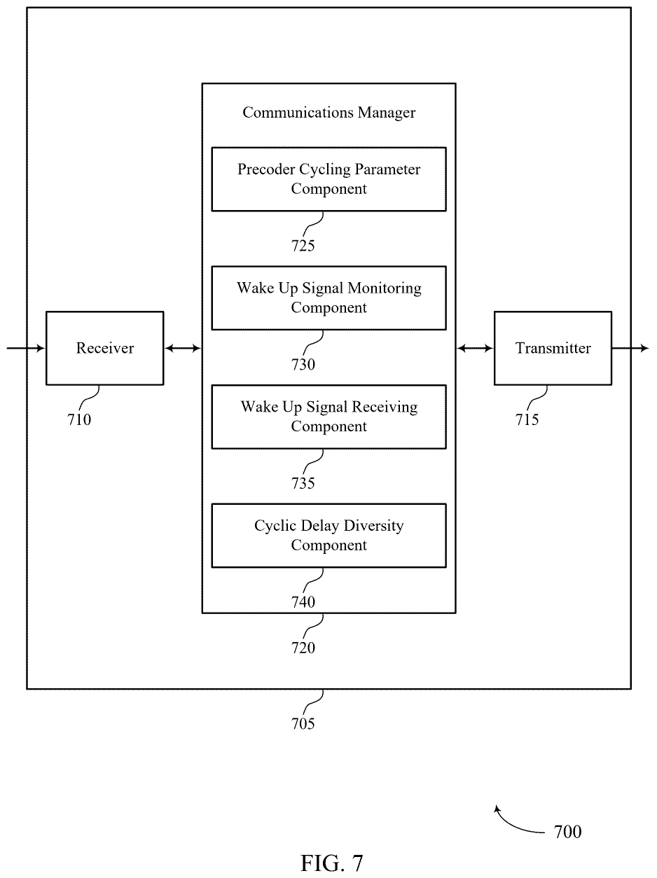

FIG. 7 shows a block diagram 700 of a device 705 that supports transmission diversity schemes for LP-WUSs in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to transmission diversity schemes for LP-WUSs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to transmission diversity schemes for LP-WUSs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of transmission diversity schemes for LP-WUSs as described herein. For example, the communications manager 720 may include a precoder cycling parameter component 725, a wake up signal monitoring component 730, a wake up signal receiving component 735, a CDD component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The precoder cycling parameter component 725 is capable of, configured to, or operable to support a means for receiving control signaling indicating a set of multiple wakeup signal resources and precoder cycling parameters including TD-PRGs, bundling TD-RBGs, or both. The wake up signal monitoring component 730 is capable of, configured to, or operable to support a means for monitoring for LP-WUSs during one or more on-durations of an OOK reception window. The wake up signal receiving component 735 is capable of, configured to, or operable to support a means for receiving the LP-WUSs in accordance with the precoder cycling parameters.

Additionally, or alternatively, the communications manager 720 may support wireless communications in accordance with examples as disclosed herein. The CDD component 740 is capable of, configured to, or operable to support a means for receiving a control message including an indication of a CDD delay value. The wake up signal monitoring component 730 is capable of, configured to, or operable to support a means for monitoring for LP-WUSs during an on-duration of an OOK reception window, where a timing of the monitoring is based on the CDD delay value. The wake up signal receiving component 735 is capable of, configured to, or operable to support a means for receiving the LP-WUSs in accordance with the timing.

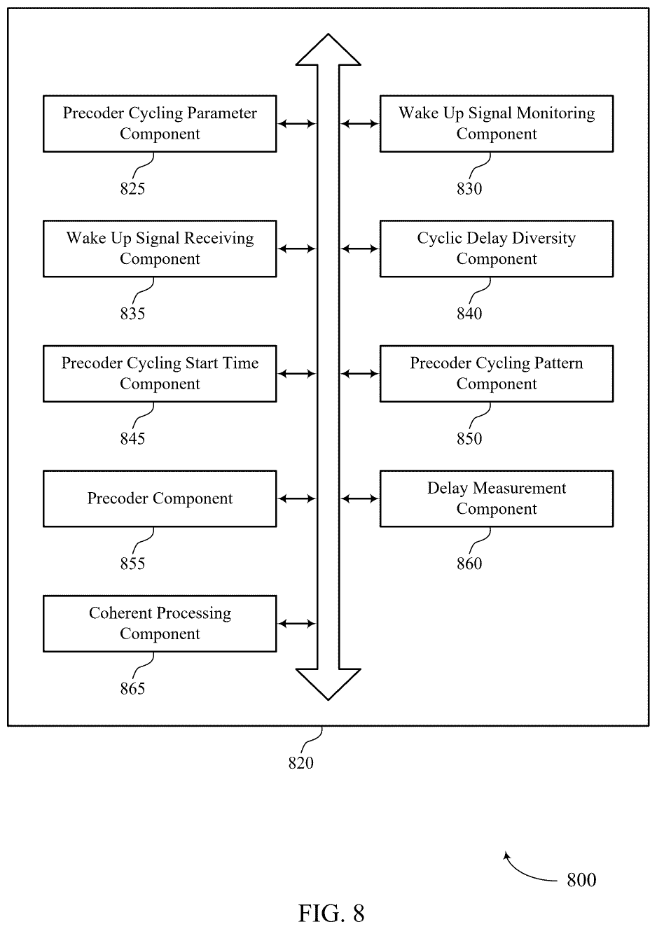

FIG. 8 shows a block diagram 800 of a communications manager 820 that supports transmission diversity schemes for LP-WUSs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of transmission diversity schemes for LP-WUSs as described herein. For example, the communications manager 820 may include a precoder cycling parameter component 825, a wake up signal monitoring component 830, a wake up signal receiving component 835, a CDD component 840, a precoder cycling start time component 845, a precoder cycling pattern component 850, a precoder component 855, a delay measurement component 860, a coherent processing component 865, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The precoder cycling parameter component 825 is capable of, configured to, or operable to support a means for receiving control signaling indicating a set of multiple wakeup signal resources and precoder cycling parameters including TD-PRGs, bundling TD-RBGs, or both. The wake up signal monitoring component 830 is capable of, configured to, or operable to support a means for monitoring for LP-WUSs during one or more on-durations of an OOK reception window. The wake up signal receiving component 835 is capable of, configured to, or operable to support a means for receiving the LP-WUSs in accordance with the precoder cycling parameters.

In some examples, the precoder cycling parameter component 825 is capable of, configured to, or operable to support a means for receiving, via the control signaling, an indication of a single bit precoder duration, where one precoder of the TD-PRGs corresponds to each of the durations.

In some examples, the precoder cycling parameter component 825 is capable of, configured to, or operable to support a means for receiving, via the control signaling, an indication of a sub-bit precoder duration, where multiple precoders of the TD-PRGs correspond to each of the on-durations.

In some examples, a quantity of the bundling TD-RBGs corresponding to the OOK reception window is based on a quantity of precoders in a cycle of precoders, such that each of the quantity of precoders occurs at least once during the quantity of the bundling TD-RBGs during the OOK reception window.

In some examples, each precoder of the cycle of precoders corresponds to a respective beam.

In some examples, a quantity of the bundling TD-RBGs is based on a subcarrier spacing configured at the UE.

In some examples, the precoder cycling start time component 845 is capable of, configured to, or operable to support a means for receiving, via the control signaling, an indication of a time period during which a first precoder of a set of multiple precoders is applied in accordance with the bundling TD-RBGs.

In some examples, the precoder cycling pattern component 850 is capable of, configured to, or operable to support a means for receiving, via the control signaling, an indication of a precoder cycling pattern, where receiving the LP-WUSs is based on applying the precoder cycling pattern.

In some examples, the precoder component 855 is capable of, configured to, or operable to support a means for receiving an indication of a precoder of a set of multiple candidate precoders to be applied to each respective TD-RBG of the bundling TD-RBGs in accordance with the TD-PRGs.

In some examples, the coherent processing component 865 is capable of, configured to, or operable to support a means for performing phase coherent processing during the on-durations of the OOK reception window on the LP-WUSs based on the indication of the precoder to be applied to each respective TD-RBG.

Additionally, or alternatively, the communications manager 820 may support wireless communications in accordance with examples as disclosed herein. The CDD component 840 is capable of, configured to, or operable to support a means for receiving a control message including an indication of a CDD delay value. In some examples, the wake up signal monitoring component 830 is capable of, configured to, or operable to support a means for monitoring for LP-WUSs during an on-duration of an OOK reception window, where a timing of the monitoring is based on the CDD delay value. In some examples, the wake up signal receiving component 835 is capable of, configured to, or operable to support a means for receiving the LP-WUSs in accordance with the timing.

In some examples, the indication of the CDD delay value includes an explicit indication of the CDD delay value.

In some examples, to support receiving the indication of the CDD delay value, the delay measurement component 860 is capable of, configured to, or operable to support a means for receiving an indication that the CDD delay value is applied to one or more RSs, where the one or more RSs are QCL with the LP-WUSs. In some examples, to support receiving the indication of the CDD delay value, the delay measurement component 860 is capable of, configured to, or operable to support a means for measuring a PDP length of the one or more RSs, where receiving the CDD delay value is determined based on the measuring.

In some examples, the one or more RSs include tracking RSs, synchronization signal block signals, or both.

In some examples, the wake up signal monitoring component 830 is capable of, configured to, or operable to support a means for adjusting the timing of the monitoring based on receiving the indication of the CDD delay value, where the timing of the monitoring corresponds to a timing of an on-off monitoring decision window.

In some examples, the coherent processing component 865 is capable of, configured to, or operable to support a means for performing phase coherent processing during the on-duration of the OOK reception window on the LP-WUSs based on the CDD delay value.

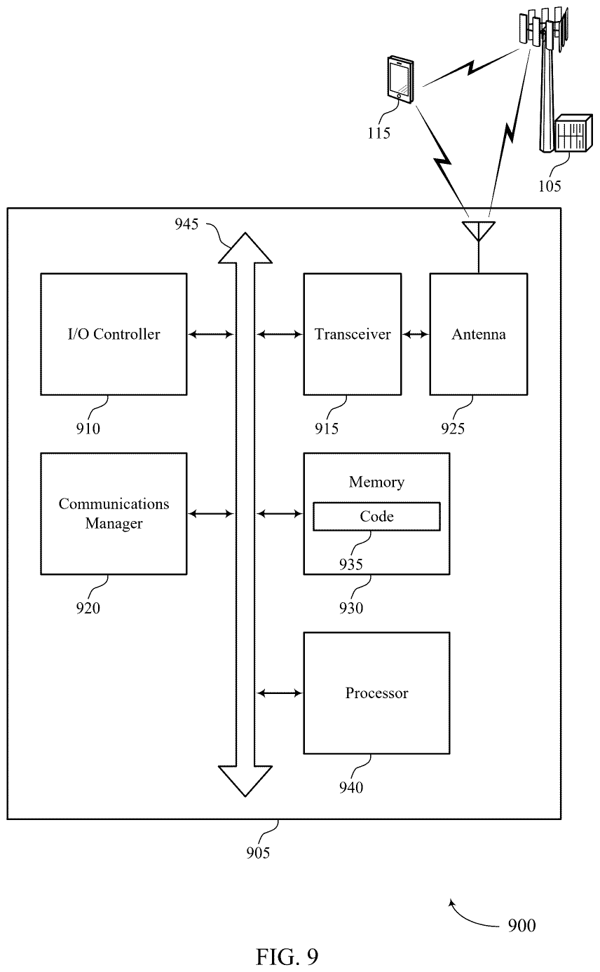

FIG. 9 shows a diagram of a system 900 including a device 905 that supports transmission diversity schemes for LP-WUSs in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting transmission diversity schemes for LP-WUSs). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling indicating a set of multiple wakeup signal resources and precoder cycling parameters including TD-PRGs, bundling TD-RBGs, or both. The communications manager 920 is capable of, configured to, or operable to support a means for monitoring for LP-WUSs during one or more on-durations of an OOK reception window. The communications manager 920 is capable of, configured to, or operable to support a means for receiving the LP-WUSs in accordance with the precoder cycling parameters.

Additionally, or alternatively, the communications manager 920 may support wireless communications in accordance with examples as disclosed herein. For example, the communications manager 920 is capable of, configured to, or operable to support a means for receiving a control message including an indication of a CDD delay value. The communications manager 920 is capable of, configured to, or operable to support a means for monitoring for LP-WUSs during an on-duration of an OOK reception window, where a timing of the monitoring is based on the CDD delay value. The communications manager 920 is capable of, configured to, or operable to support a means for receiving the LP-WUSs in accordance with the timing.

By including or configuring the communications manager 920 in accordance with examples as described herein, the device 905 may support techniques for improved communication reliability, reduced power consumption, more efficient utilization of communication resources, improved coordination between devices, and improved utilization of processing capability, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of transmission diversity schemes for LP-WUSs as described herein, or the at least one processor 940 and the at least one memory 930 may be otherwise configured to, individually or collectively, perform or support such operations.

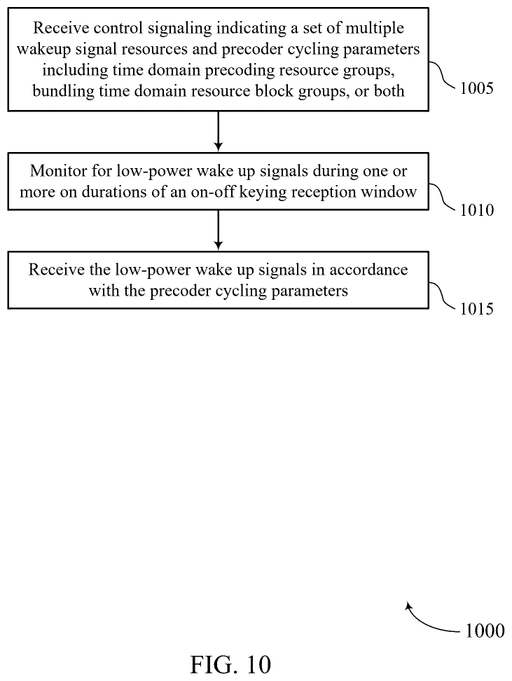

FIG. 10 shows a flowchart illustrating a method 1000 that supports transmission diversity schemes for LP-WUSs in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving control signaling indicating a set of multiple wakeup signal resources and precoder cycling parameters including TD-PRGs, bundling TD-RBGs, or both. The operations of 1005 may be performed in accordance with examples as disclosed herein. In some examples, aspects of the operations of 1005 may be performed by a precoder cycling parameter component 825 as described with reference to FIG. 8.

At 1010, the method may include monitoring for LP-WUSs during one or more on-durations of an OOK reception window. The operations of 1010 may be performed in accordance with examples as disclosed herein. In some examples, aspects of the operations of 1010 may be performed by a wake up signal monitoring component 830 as described with reference to FIG. 8.

At 1015, the method may include receiving the LP-WUSs in accordance with the precoder cycling parameters. The operations of 1015 may be performed in accordance with examples as disclosed herein. In some examples, aspects of the operations of 1015 may be performed by a wake up signal receiving component 835 as described with reference to FIG. 8.

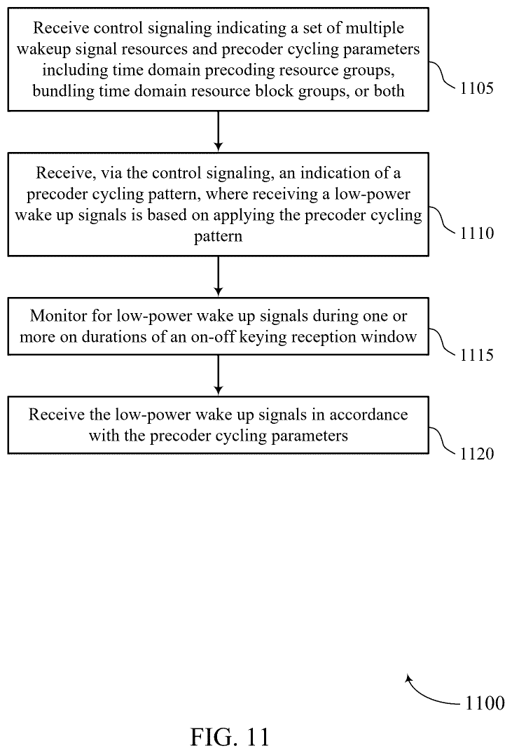

FIG. 11 shows a flowchart illustrating a method 1100 that supports transmission diversity schemes for LP-WUSs in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving control signaling indicating a set of multiple wakeup signal resources and precoder cycling parameters including TD-PRGs, bundling TD-RBGs, or both. The operations of 1105 may be performed in accordance with examples as disclosed herein. In some examples, aspects of the operations of 1105 may be performed by a precoder cycling parameter component 825 as described with reference to FIG. 8.

At 1110, the method may include receiving, via the control signaling, an indication of a precoder cycling pattern. The operations of 1110 may be performed in accordance with examples as disclosed herein. In some examples, aspects of the operations of 1110 may be performed by a precoder cycling pattern component 850 as described with reference to FIG. 8.

At 1115, the method may include monitoring for LP-WUSs during one or more on-durations of an OOK reception window. The operations of 1115 may be performed in accordance with examples as disclosed herein. In some examples, aspects of the operations of 1115 may be performed by a wake up signal monitoring component 830 as described with reference to FIG. 8.

At 1120, the method may include receiving the LP-WUSs in accordance with the precoder cycling parameters, where receiving the LP-WUSs is based on applying the precoder cycling pattern. The operations of 1120 may be performed in accordance with examples as disclosed herein. In some examples, aspects of the operations of 1120 may be performed by a wake up signal receiving component 835 as described with reference to FIG. 8.

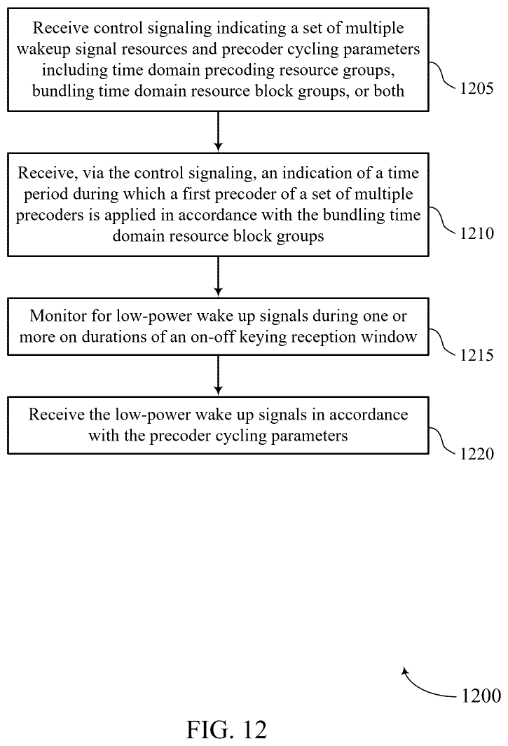

FIG. 12 shows a flowchart illustrating a method 1200 that supports transmission diversity schemes for LP-WUSs in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving control signaling indicating a set of multiple wakeup signal resources and precoder cycling parameters including TD-PRGs, bundling TD-RBGs, or both. The operations of 1205 may be performed in accordance with examples as disclosed herein. In some examples, aspects of the operations of 1205 may be performed by a precoder cycling parameter component 825 as described with reference to FIG. 8.

At 1210, the method may include receiving, via the control signaling, an indication of a time period during which a first precoder of a set of multiple precoders is applied in accordance with the bundling TD-RBGs. The operations of 1210 may be performed in accordance with examples as disclosed herein. In some examples, aspects of the operations of 1210 may be performed by a precoder cycling start time component 845 as described with reference to FIG. 8.

At 1215, the method may include monitoring for LP-WUSs during one or more on-durations of an OOK reception window. The operations of 1215 may be performed in accordance with examples as disclosed herein. In some examples, aspects of the operations of 1215 may be performed by a wake up signal monitoring component 830 as described with reference to FIG. 8.

At 1220, the method may include receiving the LP-WUSs in accordance with the precoder cycling parameters. The operations of 1220 may be performed in accordance with examples as disclosed herein. In some examples, aspects of the operations of 1220 may be performed by a wake up signal receiving component 835 as described with reference to FIG. 8.

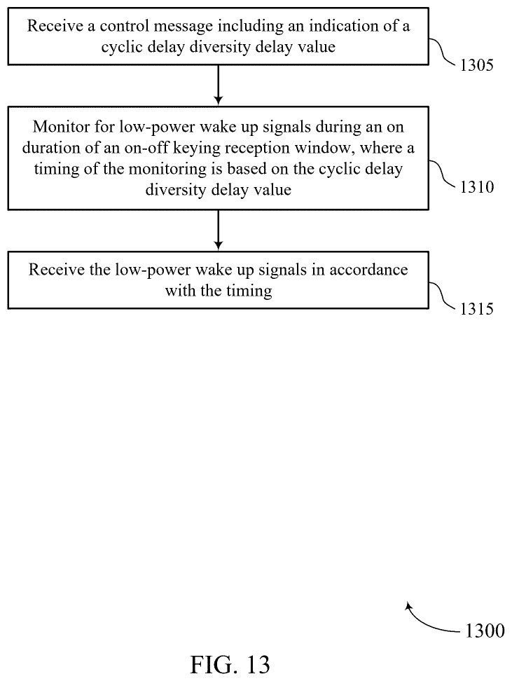

FIG. 13 shows a flowchart illustrating a method 1300 that supports transmission diversity schemes for LP-WUSs in accordance with one or more aspects of the present disclosure. The operations of the method 1300 may be implemented by a UE or its components as described herein. For example, the operations of the method 1300 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1305, the method may include receiving a control message including an indication of a CDD delay value. The operations of 1305 may be performed in accordance with examples as disclosed herein. In some examples, aspects of the operations of 1305 may be performed by a CDD component 840 as described with reference to FIG. 8.

At 1310, the method may include monitoring for LP-WUSs during an on-duration of an OOK reception window, where a timing of the monitoring is based on the CDD delay value. The operations of 1310 may be performed in accordance with examples as disclosed herein. In some examples, aspects of the operations of 1310 may be performed by a wake up signal monitoring component 830 as described with reference to FIG. 8.

At 1315, the method may include receiving the LP-WUSs in accordance with the timing. The operations of 1315 may be performed in accordance with examples as disclosed herein. In some examples, aspects of the operations of 1315 may be performed by a wake up signal receiving component 835 as described with reference to FIG. 8.

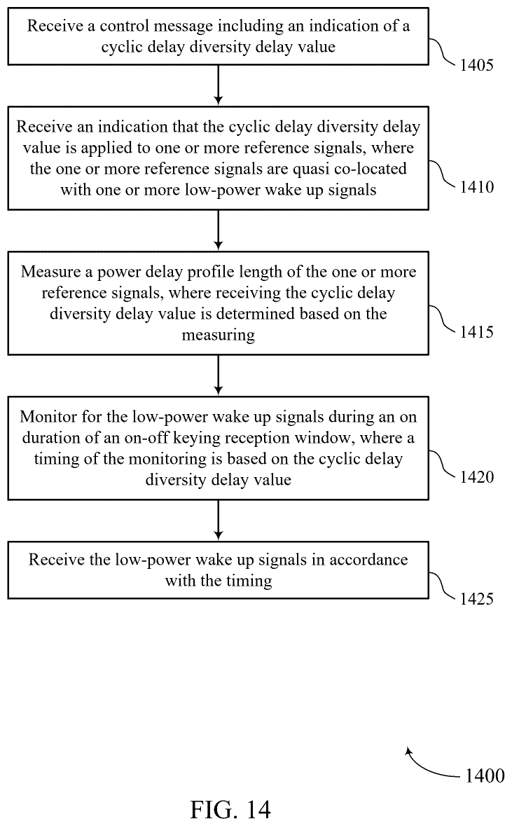

FIG. 14 shows a flowchart illustrating a method 1400 that supports transmission diversity schemes for LP-WUSs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a control message including an indication of a CDD delay value. The operations of 1405 may be performed in accordance with examples as disclosed herein. In some examples, aspects of the operations of 1405 may be performed by a CDD component 840 as described with reference to FIG. 8.

At 1410, the method may include receiving an indication that the CDD delay value is applied to one or more RSs, where the one or more RSs are QCL with one or more LP-WUSs. The operations of 1410 may be performed in accordance with examples as disclosed herein. In some examples, aspects of the operations of 1410 may be performed by a delay measurement component 860 as described with reference to FIG. 8.

At 1415, the method may include measuring a PDP length of the one or more RSs, where receiving the CDD delay value is determined based on the measuring. The operations of 1415 may be performed in accordance with examples as disclosed herein. In some examples, aspects of the operations of 1415 may be performed by a delay measurement component 860 as described with reference to FIG. 8.

At 1420, the method may include monitoring for LP-WUSs during an on-duration of an OOK reception window, where a timing of the monitoring is based on the CDD delay value. The operations of 1420 may be performed in accordance with examples as disclosed herein. In some examples, aspects of the operations of 1420 may be performed by a wake up signal monitoring component 830 as described with reference to FIG. 8.

At 1425, the method may include receiving the LP-WUSs in accordance with the timing. The operations of 1425 may be performed in accordance with examples as disclosed herein. In some examples, aspects of the operations of 1425 may be performed by a wake up signal receiving component 835 as described with reference to FIG. 8.

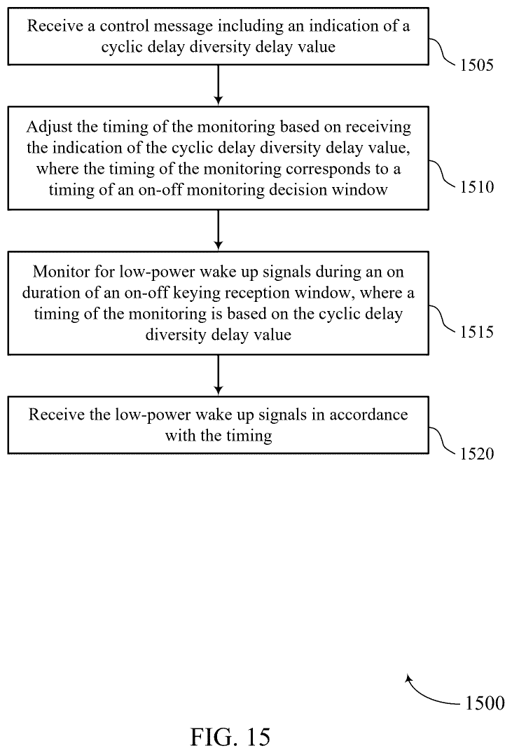

FIG. 15 shows a flowchart illustrating a method 1500 that supports transmission diversity schemes for LP-WUSs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a control message including an indication of a CDD delay value. The operations of 1505 may be performed in accordance with examples as disclosed herein. In some examples, aspects of the operations of 1505 may be performed by a CDD component 840 as described with reference to FIG. 8.

At 1510, the method may include adjusting the timing of the monitoring based on receiving the indication of the CDD delay value, where the timing of the monitoring corresponds to a timing of an on-off monitoring decision window. The operations of 1510 may be performed in accordance with examples as disclosed herein. In some examples, aspects of the operations of 1510 may be performed by a wake up signal monitoring component 830 as described with reference to FIG. 8.

At 1515, the method may include monitoring for LP-WUSs during an on-duration of an OOK reception window, where a timing of the monitoring is based on the CDD delay value. The operations of 1515 may be performed in accordance with examples as disclosed herein. In some examples, aspects of the operations of 1515 may be performed by a wake up signal monitoring component 830 as described with reference to FIG. 8.

At 1520, the method may include receiving the LP-WUSs in accordance with the timing. The operations of 1520 may be performed in accordance with examples as disclosed herein. In some examples, aspects of the operations of 1520 may be performed by a wake up signal receiving component 835 as described with reference to FIG. 8.

The following provides an overview of aspects of the present disclosure:

Aspect 1: A method for wireless communications by a UE, comprising: receiving control signaling indicating a plurality of wakeup signal resources and precoder cycling parameters comprising TD-PRGs, bundling TD-RBGs, or both; monitoring for LP-WUSs during one or more on-durations of an OOK reception window; and receiving the LP-WUSs in accordance with the precoder cycling parameters.

Aspect 2: The method of aspect 1, further comprising: receiving, via the control signaling, an indication of a single bit precoder duration, wherein one precoder of the TD-PRGs corresponds to each of the durations.

Aspect 3: The method of aspect 1, further comprising: receiving, via the control signaling, an indication of a sub-bit precoder duration, wherein multiple precoders of the TD-PRGs correspond to each of the on-durations.

Aspect 4: The method of any of aspects 1 through 3, wherein a quantity of the bundling TD-RBGs corresponding to the OOK reception window is based at least in part on a quantity of precoders in a cycle of precoders, such that each of the quantity of precoders occurs at least once during the quantity of the bundling TD-RBGs during the OOK reception window.

Aspect 5: The method of aspect 4, wherein each precoder of the cycle of precoders corresponds to a respective beam.

Aspect 6: The method of any of aspects 1 through 5, wherein a quantity of the bundling TD-RBGs is based at least in part on a subcarrier spacing configured at the UE.

Aspect 7: The method of any of aspects 1 through 6, further comprising: receiving, via the control signaling, an indication of a time period during which a first precoder of a plurality of precoders is applied in accordance with the bundling TD-RBGs.

Aspect 8: The method of any of aspects 1 through 7, further comprising: receiving, via the control signaling, an indication of a precoder cycling pattern, wherein receiving the LP-WUSs is based at least in part on applying the precoder cycling pattern.

Aspect 9: The method of aspect 1, further comprising: receiving an indication of a precoder of a plurality of candidate precoders to be applied to each respective TD-RBG of the bundling TD-RBGs in accordance with the TD-PRGs.

Aspect 10: The method of aspect 9, further comprising: performing phase coherent processing during the on-durations of the OOK reception window on the LP-WUSs based at least in part on the indication of the precoder to be applied to each respective TD-RBG.

Aspect 11: A method for wireless communications by a UE, comprising: receiving a control message comprising an indication of a CCD delay value; monitoring for LP-WUSs during an on-duration of an OOK reception window, wherein a timing of the monitoring is based at least in part on the CCD delay value; and receiving the LP-WUSs in accordance with the timing.

Aspect 12: The method of aspect 11, wherein the indication of the CCD delay value comprises an explicit indication of the CCD delay value.

Aspect 13: The method of aspect 11, wherein receiving the indication of the CCD delay value further comprises: receiving an indication that the CCD delay value is applied to one or more RSs, wherein the one or more RSs are QCL with the LP-WUSs; and measuring a power delay profile length of the one or more RSs, wherein receiving the CCD delay value is determined based at least in part on the measuring.

Aspect 14: The method of aspect 13, wherein the one or more RSs comprise tracking RSs, SSB signals, or both.

Aspect 15: The method of any of aspects 11 through 14, further comprising: adjusting the timing of the monitoring based at least in part on receiving the indication of the CCD delay value, wherein the timing of the monitoring corresponds to a timing of an on-off monitoring decision window.

Aspect 16: The method of any of aspects 11 through 15, further comprising: performing phase coherent processing during the on-duration of the OOK reception window on the LP-WUSs based at least in part on the CCD delay value.

Aspect 17: A UE for wireless communications, comprising one or more memories storing processor-executable code, and one or more processors coupled with the one or more memories and individually or collectively operable to execute the code to cause the UE to perform a method of any of aspects 1 through 10.

Aspect 18: A UE for wireless communications, comprising at least one means for performing a method of any of aspects 1 through 10.

Aspect 19: A non-transitory computer-readable medium storing code for wireless communications, the code comprising instructions executable by one or more processors to perform a method of any of aspects 1 through 10.

Aspect 20: A UE for wireless communications, comprising one or more memories storing processor-executable code, and one or more processors coupled with the one or more memories and individually or collectively operable to execute the code to cause the UE to perform a method of any of aspects 11 through 16.

Aspect 21: A UE for wireless communications, comprising at least one means for performing a method of any of aspects 11 through 16.

Aspect 22: A non-transitory computer-readable medium storing code for wireless communications, the code comprising instructions executable by one or more processors to perform a method of any of aspects 11 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling indicating a plurality of wakeup signal resources and precoder cycling parameters comprising time domain precoding resource groups, bundling time domain resource block groups, or both;
monitor for low-power wake up signals during on-durations of an on-off keying reception window; and
receive the low-power wake up signals in accordance with the precoder cycling parameters.

2. The UE of claim 1, wherein the one or more processors are individually or collectively further operable to execute the code to cause the UE to:
receive, via the control signaling, an indication of a single bit precoder duration, wherein one precoder of the time domain precoding resource groups corresponds to each of the on-durations.

3. The UE of claim 1, wherein the one or more processors are individually or collectively further operable to execute the code to cause the UE to:
receive, via the control signaling, an indication of a sub-bit precoder duration, wherein multiple precoders of the time domain precoding resource groups correspond to each of the on-durations.

4. The UE of claim 1, wherein a quantity of the bundling time domain resource block groups corresponding to the on-off keying reception window is based at least in part on a quantity of precoders in a cycle of precoders, such that each of the quantity of precoders occurs at least once during the quantity of the bundling time domain resource block groups during the on-off keying reception window.

5. The UE of claim 4, wherein each precoder of the cycle of precoders corresponds to a respective beam.

6. The UE of claim 1, wherein a quantity of the bundling time domain resource block groups is based at least in part on a subcarrier spacing configured at the UE.

7. The UE of claim 1, wherein the one or more processors are individually or collectively further operable to execute the code to cause the UE to:
receive, via the control signaling, an indication of a time period during which a first precoder of a plurality of precoders is applied in accordance with the bundling time domain resource block groups.

8. The UE of claim 1, wherein the one or more processors are individually or collectively further operable to execute the code to cause the UE to:
receive, via the control signaling, an indication of a precoder cycling pattern, wherein receiving the low-power wake up signals is based at least in part on applying the precoder cycling pattern.

9. The UE of claim 1, wherein the one or more processors are individually or collectively further operable to execute the code to cause the UE to:
receive an indication of a precoder of a plurality of candidate precoders to be applied to each respective time domain resource block group of the bundling time domain resource block groups in accordance with the time domain precoding resource groups.

10. The UE of claim 9, wherein the one or more processors are individually or collectively further operable to execute the code to cause the UE to:
perform phase coherent processing during the on-durations of the on-off keying reception window on the low-power wake up signals based at least in part on the indication of the precoder to be applied to each respective time domain resource block group.

11. A user equipment (UE), comprising:
one or more memories storing processor-executable code; and
one or more processors coupled with the one or more memories and individually or collectively operable to execute the code to cause the UE to:
receive a control message comprising an indication of a cyclic delay diversity delay value;
monitor for low-power wake up signals during an on-duration of an on-off keying reception window, wherein a timing of the monitoring is based at least in part on the cyclic delay diversity delay value; and
receive the low-power wake up signals in accordance with the timing.

12. The UE of claim 11, wherein the indication of the cyclic delay diversity delay value comprises an explicit indication of the cyclic delay diversity delay value.

13. The UE of claim 11, wherein, to receive the indication of the cyclic delay diversity delay value, the one or more processors are individually or collectively further operable to execute the code to cause the UE to:
receive an indication that the cyclic delay diversity delay value is applied to one or more reference signals, wherein the one or more reference signals are quasi co-located with the low-power wake up signals; and
measure a power delay profile length of the one or more reference signals, wherein receiving the cyclic delay diversity delay value is determined based at least in part on the measuring.

14. The UE of claim 13, wherein the one or more reference signals comprise tracking reference signals, synchronization signal block signals, or both.

15. The UE of claim 11, wherein the one or more processors are individually or collectively further operable to execute the code to cause the UE to:
adjust the timing of the monitoring based at least in part on receiving the indication of the cyclic delay diversity delay value, wherein the timing of the monitoring corresponds to a timing of an on-off monitoring decision window.

16. The UE of claim 11, wherein the one or more processors are individually or collectively further operable to execute the code to cause the UE to:
perform phase coherent processing during the on-duration of the on-off keying reception window on the low-power wake up signals based at least in part on the cyclic delay diversity delay value.

17. A method for wireless communications by a user equipment (UE), comprising:
receiving control signaling indicating a plurality of wakeup signal resources and precoder cycling parameters comprising time domain precoding resource groups, bundling time domain resource block groups, or both;
monitoring for low-power wake up signals during one or more on-durations of an on-off keying reception window; and
receiving the low-power wake up signals in accordance with the precoder cycling parameters.

18. The method of claim 17, further comprising:
receiving, via the control signaling, an indication of a single bit precoder duration, wherein one precoder of the time domain precoding resource groups corresponds to each of the on-durations.

19. The method of claim 17, further comprising:
receiving, via the control signaling, an indication of a sub-bit precoder duration, wherein multiple precoders of the time domain precoding resource groups correspond to each of the on-durations.

20. The method of claim 17, wherein a quantity of the bundling time domain resource block groups corresponding to the on-off keying reception window is based at least in part on a quantity of precoders in a cycle of precoders, such that each of the quantity of precoders occurs at least once during the quantity of the bundling time domain resource block groups during the on-off keying reception window.
